(19) United States
(12) Patent Application Publication
(10) Pub. No.: US 2018/0156541 A1
(43) Pub. Date: Jun. 7, 2018

(54) BURNER AND SPREADING ARRANGEMENT FOR A BURNER

(71) Applicant: OUTOTEC (FINLAND) OY, Espoo (FI)

(72) Inventors: Elli MIETTINEN, Espoo (FI); Sarianna SUOMINEN, Espoo (FI); Lauri P. PESONEN, Oakville, Ontario (CA); Aki LAANINEN, Espoo (FI); Tapio AHOKAINEN, Helsinki (FI); Kaj EKLUND, Pori (FI); Markku LAHTINEN, Espoo (FI); Peter BJÖRKLUND, Espoo (FI)

(73) Assignee: OUTOTEC (FINLAND) OY, Espoo (FI)

(21) Appl. No.: 15/564,150

(22) PCT Filed: Apr. 7, 2016
(86) PCT No.: PCT/FI2016/050215

§ 371 Date: Oct. 3, 2017

(30) Foreign Application Priority Data
Apr. 8, 2015 (FI) 20155255

(51) Int. Cl. F27D 99/00

(52) U.S. Cl. CPC F27D 99/0033; F27D 2099/004

(57) ABSTRACT

Provided is a burner such as a concentrate burner or a matte burner for feeding reaction gas and fine solids into a reaction shaft of a suspension smelting furnace. The burner comprises an annular fine solids discharge channel that is radially limited at the outside by a first annular wall and that is radially limited at the inside by a second annular wall. The annular fine solids discharge channel is configured to receive fine solids from a fine solids feeding arrangement and to create an annular flow of fine solids in the annular fine solids discharge channel. The annular fine solids discharge channel being provided with spreading means configured to be hit by the annular flow of fine solids and configured to even out particle distribution in the annular flow of fine solids.

### FIELD OF THE INVENTION

The invention relates to a burner such as a concentrate burner or a matte burner for feeding reaction gas and fine solids into a reaction shaft of a suspension smelting furnace as defined in the preamble of independent claim 1.

Good annular distribution of fine solids feed is a key factor in achieving good reaction efficiency such as good oxygen efficiency of a concentrate burner or matte burner.

### OBJECTIVE OF THE INVENTION

The object of the invention is to provide a burner which provides good annular distribution of fine solids feed.

### SHORT DESCRIPTION OF THE INVENTION

The burner of the invention is characterized by the definitions of independent claim 1.

Preferred embodiments of the burner are defined in the dependent claims 2 to 15.

The invention relates also to a spreading arrangement defined in claim 16 for use in a burner according to any of the claims 1 to 15.

A preferred embodiment of the spreading arrangement is presented in dependent claim 17.

The invention relates also to a spreading arrangement characterized by the definitions of independent claim 18.

A preferred embodiment of the spreading arrangement is presented in dependent claim 19.

### LIST OF FIGURES

In the following the invention will described in more detail by referring to the figures, which

FIG. 1 is a schematic illustration of a suspension smelting furnace,

FIG. 2 is another schematic illustration of a suspension smelting furnace,

FIG. 3 is a schematic illustration of a burner according to a first embodiment,

FIG. 4 is a schematic illustration of a burner according to a second embodiment,

FIG. 5 is a schematic illustration of a burner according to a third embodiment,

FIG. 6 is a schematic illustration of a burner according to a fourth embodiment,

FIG. 7 is a schematic illustration of a burner according to a fifth embodiment,

FIG. 8 is a schematic illustration of a burner according to a sixth embodiment,

FIG. 9 is a schematic illustration of a burner according to a seventh embodiment,

FIG. 10 shows the annular fine solids discharge channel and the fine solids dispersion device of the burner shown in FIG. 6 in cross-section,

FIG. 11 shows the annular fine solids discharge channel and the fine solids dispersion device of the burner shown in FIG. 7 in cross-section,

FIG. 12 shows the annular fine solids discharge channel and the fine solids dispersion device of the burner shown in FIG. 8 in cross-section,

FIG. 13 shows the annular fine solids discharge channel and the fine solids dispersion device of the burner shown in FIG. 9 in cross-section,

FIG. 14 is a schematic illustration of a burner according to an eight embodiment,

FIG. 15 is a schematic illustration of a burner according to a ninth embodiment, and

FIGS. 16 and 17 shows an embodiment of a spreading arrangement for a burner for a suspension smelting furnace.

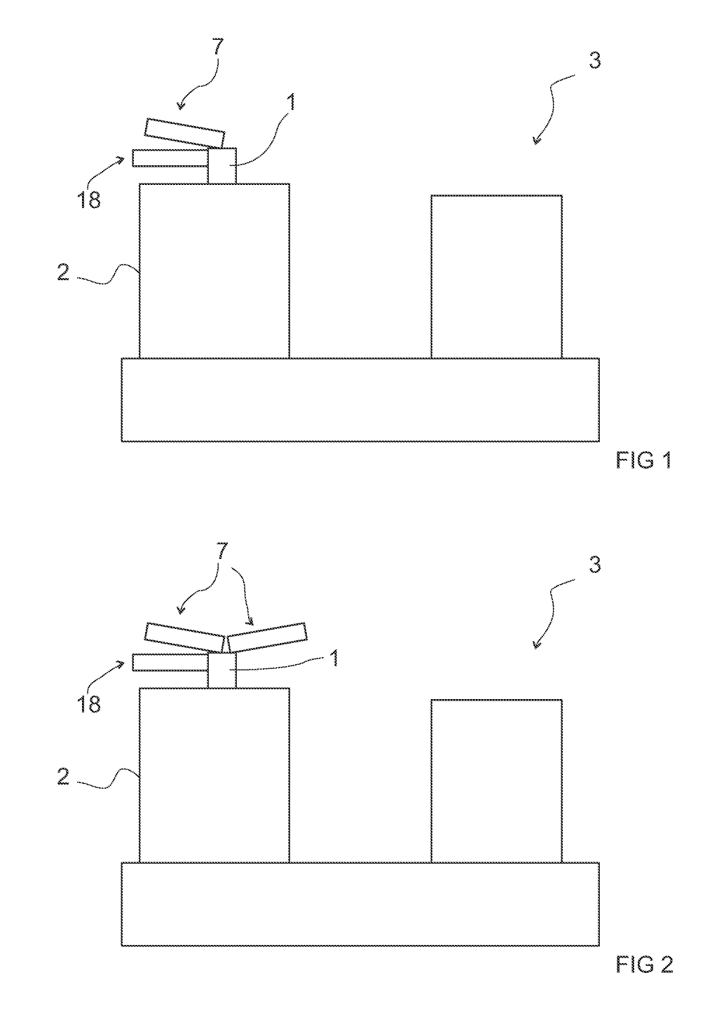

### DETAILED DESCRIPTION OF THE INVENTION

The invention relates to a burner 1 such as to concentrate burner of matte burner for feeding reaction gas (not shown in the figures) and fine solids (not shown in the figures) such as concentrate, sulfidic non-ferrous concentrate, flux (Si and/or Ca based), recycled process dust and reverts (recycled fine material) into a reaction shaft 2 of a suspension smelting furnace 3 such as into the reaction shaft 2 of a flash smelting furnace.

The burner comprises an annular fine solids discharge channel 4 that is radially limited at the outside by a first annular wall 5 and that is radially limited at the inside by a second annular wall 6.

The annular fine solids discharge channel 4 is configured to receive fine solids from a fine solids feeding arrangement 7 and to create an annular flow (not shown in the figures) of fine solids in the annular fine solids discharge channel 4.

The annular fine solids discharge channel 4 may additionally be configured to receive reaction gas such as technical oxygen or oxygen enriched air from a reaction gas feeding arrangement 18 so that the annular flow of fine solids in the annular fine solids discharge channel 4 additionally contains reaction gas.

The annular fine solids discharge channel 4 is provided with spreading means 8 configured to be hit by the annular flow of fine solids and configured to even out particle distribution in the annular flow of fine solids in the annular fine solids discharge channel 4.

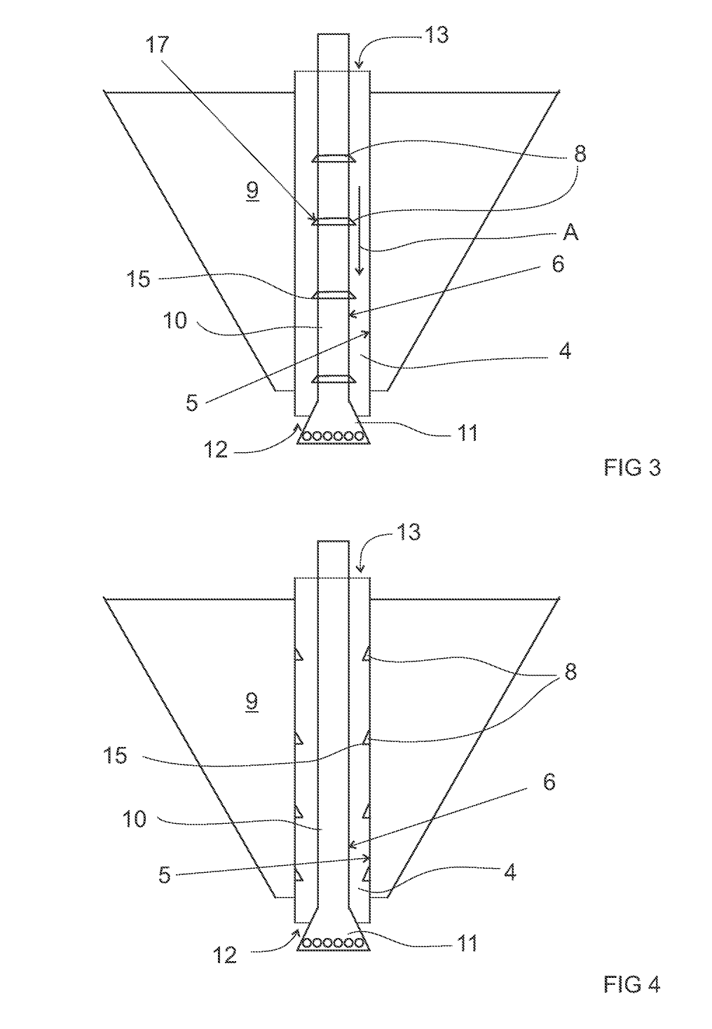

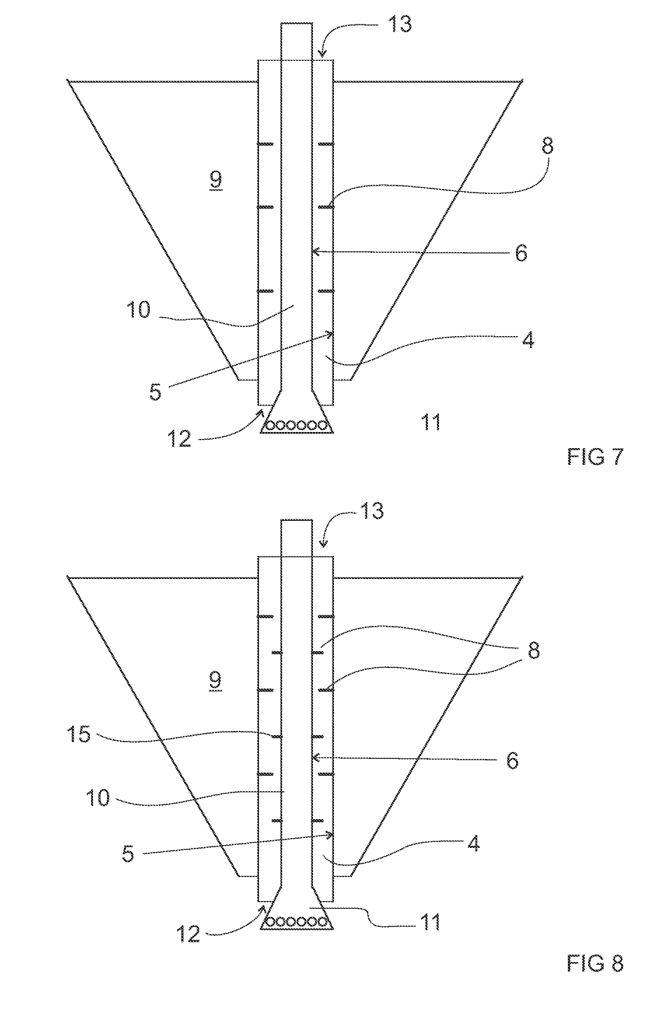

The first annular wall 5 can be an inner wall of a reaction gas feeding means 9 that surrounds the annular fine solids discharge channel 4 and the second annular wall 6 can be formed by an outer wall of a fine solids dispersion device 10 in the annular fine solids discharge channel 4, as in the embodiments illustrated in FIGS. 3 to 9.

The fine solids dispersion device 10 in the annular fine solids discharge channel 4 can, as in the embodiments illustrated in FIGS. 3 to 8, have an enlarged section 11 at an annular outlet opening 12 of the annular fine solids discharge channel 4, and the spreading means 8 may be being arranged in the annular fine solids discharge channel 4 upstream of said enlarged section 11.

The annular fine solids discharge channel 4 may have an annular inlet opening 13 and an annular outlet opening 12.

The burner 1 may comprise a spreading means 8 that is unattached to the first annular wall 5 and that is attached to the second annular wall 6.

For example in the embodiments illustrated in FIGS. 3, 5, 6, and 8, the burner 1 comprises spreading means 8, which are attached to the wall of the fine solids dispersion device 10 forming the second annular wall 6 and which are unattached to the inner wall of the reaction gas feeding means 9 forming the first annular wall 5.

The burner 1 may comprise a spreading means 8 that is unattached to the first annular wall 5, that is attached to the second annular wall 6 and that has a first free end 15 that is situated at a distance from the first annular wall 5. For example in the embodiments illustrated in FIGS. 3, 5, 6, and 8 the burner 1 comprises spreading means 8, which are unattached to the inner wall of the reaction gas feeding means 9 forming the first annular wall 5, which are attached to the wall fine solids dispersion device 10 forming the second annular wall 6, and which has a first free end 15 that is situated at a distance from the inner wall of the reaction gas feeding means 9 forming the first annular wall 5. An advantage with this embodiment is that because the spreading means 8 has a first free end 15 that is situated at a distance from the first annular wall 5, thermal expansion of the spreading means 8 is possible.

The burner 1 may have a spreading means 8 that is attached to the first annular wall 5 and that is unattached to the second annular wall 6. For example in the embodiments illustrated in FIGS. 4, 5, 6, and 8, the burner 1 comprises spreading means 8, which are attached to the inner wall of the reaction gas feeding means 9 forming the first annular wall 5 and which are unattached to the wall of the fine solids dispersion device 10 forming the second annular wall 6.

The burner 1 may have a spreading means 8 that is attached to the first annular wall 5, that is unattached to the second annular wall 6, and that has a first free end 15 that is situated at a distance from the second annular wall 6. For example in the embodiments illustrated in FIGS. 4, 5, 6, and 8, the burner 1 comprises spreading means 8, which are attached to the inner wall of the annular fine solids discharge channel 4 forming the first annular wall 5, which are unattached to the wall of the fine solids dispersion device 10 forming the second annular wall 6, and which are situated at a distance from the wall of the annular fine solids discharge channel 4 forming the second annular wall 6 and that has a first free end 15 that is situated at a distance from the wall of the fine solids dispersion device 10 forming the second annular wall 6. An advantage with this embodiment is that because the spreading means 8 has a first free end 15 that is situated at a distance from the second annular wall 6, thermal expansion of the spreading means 8 is possible.

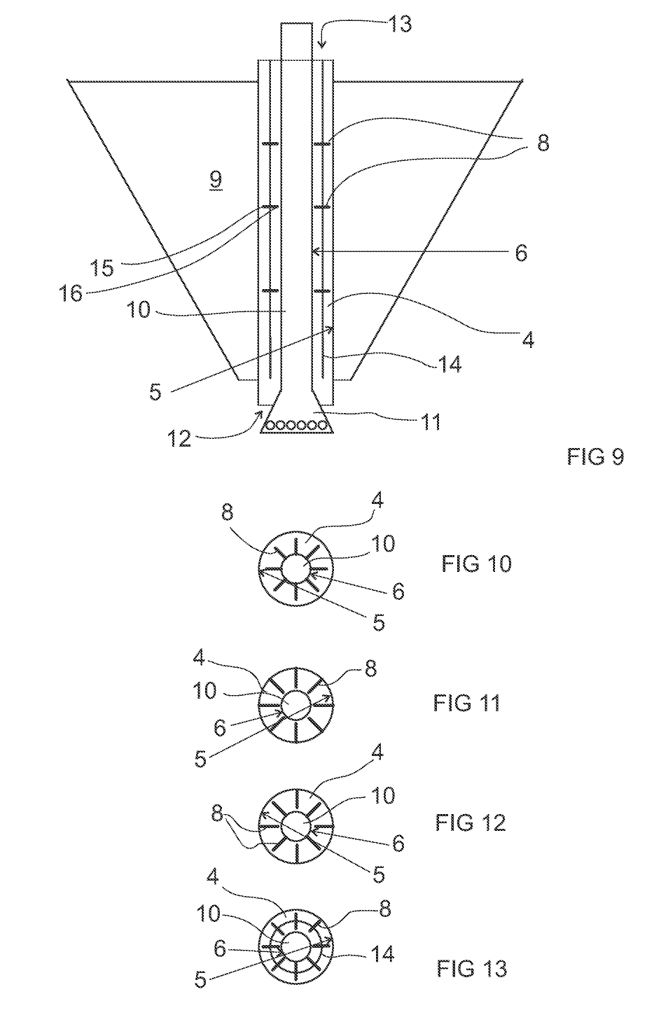

The burner 1 may, as illustrated in FIG. 9, have a spreading means 8, which is attached to a separate supporting structure 14 arranged in the annular fine solids discharge channel 4, and which is unattached to the first annular wall 5, and which is unattached to the second annular wall 6.

In the embodiment illustrated in FIG. 9, the burner has spreading means 8, which are attached to a separate supporting structure 14, which is unattached to the wall of the fine solids dispersion device 10, and which is unattached to the inner wall of the reaction gas feeding means 9.

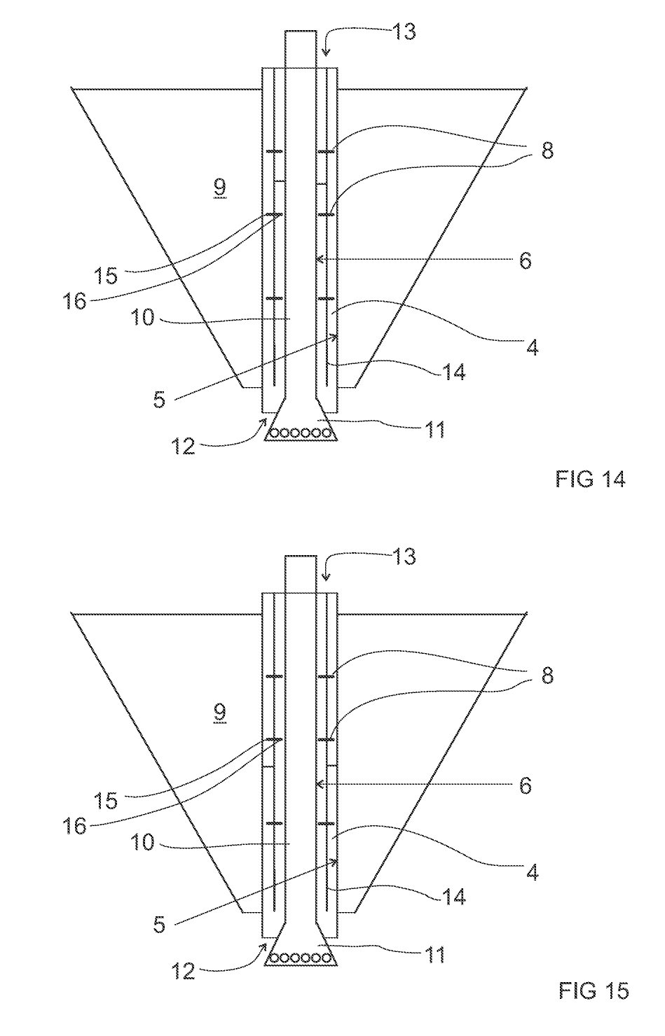

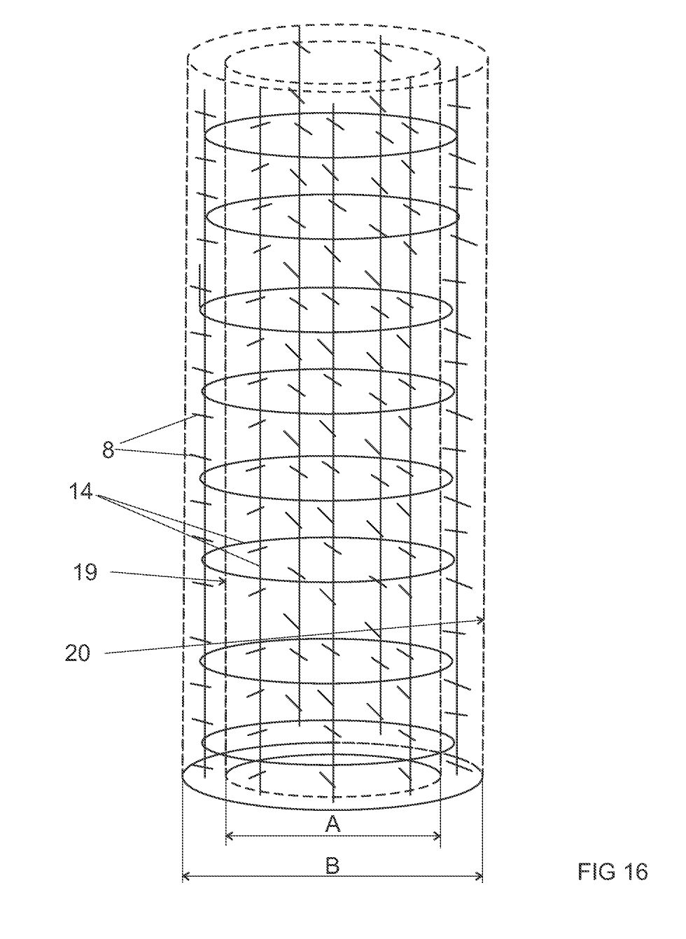

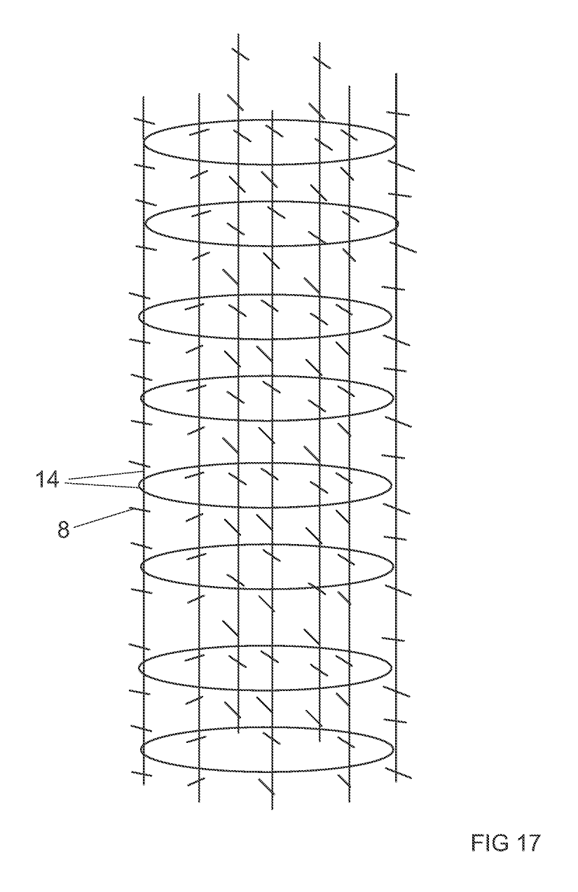

The burner 1 may, as illustrated in FIG. 14, have a spreading means 8, which is attached to a separate supporting structure 14 arranged in the annular fine solids discharge channel 4, and which is unattached to the first annular wall 5, and which is attached to the second annular wall 6.

In the embodiment illustrated in FIG. 14, the burner has spreading means 8, which are attached to a separate supporting structure 14, which is unattached to the wall of the fine solids dispersion device 10, and which is attached to the inner wall of the reaction gas feeding means 9.

The burner 1 may, as illustrated in FIG. 15, have a spreading means 8, which is attached to a separate supporting structure 14 arranged in the annular fine solids discharge channel 4, and which is attached to the first annular wall 5, and which is unattached to the second annular wall 6.

In the embodiment illustrated in FIG. 15, the burner has spreading means 8, which are attached to a separate supporting structure 14, which is unattached to the wall of the fine solids dispersion device 10, and which is unattached to the inner wall of the reaction gas feeding means 9.

The burner 1 may, as illustrated in FIG. 9, have a spreading means 8, which is attached to a separate supporting structure 14 arranged in the annular fine solids discharge channel 4 so that the spreading means 8, which is attached to the separate supporting structure 14, is unattached to the first annular wall 5 and unattached to the second annular wall 6, and so that the spreading means 8 which are attached to the separate supporting structure 14 have a first free end 15 that is situated at a distance from the first annular wall 5 and a second free end 16 that is situated at a distance from the second annular wall 6. An advantage with this embodiment is that because the spreading means 8 has a first free end 15 that is situated at a distance from the first annular wall 5 and a second free end 16 that is situated at a distance from the first annular wall 6, thermal expansion of the spreading means 8 is possible

In the embodiment illustrated in FIG. 9 this means that the burner has a spreading means 8, which is attached to a separate supporting structure 14 so that the spreading means 8, which is attached to a separate supporting structure 14, is unattached to the wall of the fine solids dispersion device 10 and unattached to the wall of the annular fine solids discharge channel 4, and so that the spreading means 8 which is attached to the separate supporting structure 14 have a first free end 15 that is situated at a distance from the inner wall of the reaction gas feeding means 9 and a second free end 16 that is situated at a distance from the wall of the fine solids dispersion device 10.

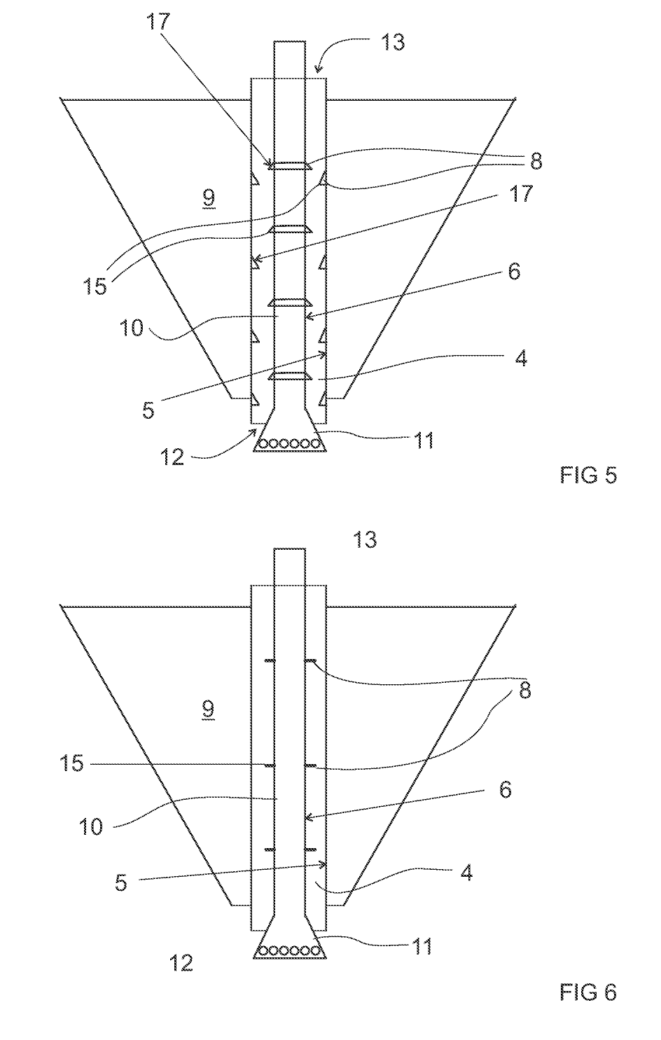

The burner 1 may, as in the embodiments illustrated in FIGS. 6, 7, 8, and 9 comprise a spreading means 8 in the form of a rod having a circular cross-section. Alternatively, the burner 1 may comprise a spreading means 8 in the form of a rod having a triangular, rectangular, or a square cross-section.

The burner 1 may comprise a spreading means 8 in the form of a rod extending at least partly perpendicularly with respect to a direction of flow A of the annular flow of fine solids in wall of the annular fine solids discharge channel 4.

The burner 1 may, as in the embodiments illustrated in FIGS. 3, 4, and 5 comprise at least one spreading means 8 in the form of an annular spreading means 8 that is attached to either the first annular wall 5 or to the second annular wall 6. Such annular spreading means 8 is preferably, but not necessarily, conical so that the annular spreading means 8 has an impact surface 17 that slanted and/or curved with respect to a direction of flow A of the annular flow of fine solids in the annular fine solids discharge channel 4.

Next the spreading arrangement for use in a burner 1 of a suspension smelting furnace 3 according to any embodiment described herein will be described in greater detail.

The spreading arrangement is configured to releasable or fixedly arranged in an annular fine solids discharge channel 4 of the burner of the suspension smelting furnace 3, which annular fine solids discharge channel 4 is radially limited on the outside by a first annular wall 5 and which annular fine solids discharge channel 5 is radially limited at the inside by a second annular wall 6.

The first annular wall 5 can be an inner wall of a reaction gas feeding means 9 that surrounds the annular fine solids discharge channel 4 and the second annular wall 6 can be formed by an outer wall of a fine solids dispersion device 10 in the annular fine solids discharge channel 4, as in the embodiments illustrated in FIGS. 3 to 9.

The spreading arrangement comprises a separate supporting structure 14 and a plurality of spreading means 8 attached to the separate supporting structure 14. The spreading arrangement has a tubular configuration so that the spreading arrangement is radially inwardly limited by a first imaginary cylindrical surface 19 and so that the spreading arrangement is radially outwardly limited by a second imaginary cylindrical surface 20.

The first imaginary cylindrical surface 19 has preferably, but not necessarily, a first diameter A between 100 mm and 300 mm, and the second imaginary cylindrical surface 20 has preferably, but not necessarily, a second diameter B between 300 mm and 700 mm, depending on the burner capacity.

Next the spreading arrangement configured to be arranged in an annular fine solids discharge channel 4 of a burner 1 such as of a concentrate burner or of a matte burner of a suspension smelting furnace 3, which annular fine solids discharge channel 4 is radially limited on the outside by a first annular wall 5 of the burner 1 and which annular fine solids discharge channel 5 is radially limited at the inside by a second annular wall 6 of the burner 1.

The first annular wall 5 of the burner 1 can be an inner wall of a reaction gas feeding means 9 that surrounds the annular fine solids discharge channel 4 of the burner 1 and the second annular wall 6 of the burner 1 can be formed by an outer wall of a fine solids dispersion device 10 in the annular fine solids discharge channel 4 of the burner, as in the embodiments illustrated in FIGS. 3 to 9.

The spreading arrangement comprises a separate supporting structure 14 and a plurality of spreading means 8 attached to the separate supporting structure 14. The spreading arrangement has a tubular configuration so that the spreading arrangement is radially inwardly limited by a first imaginary cylindrical surface 19 and so that the spreading arrangement is radially outwardly limited by a second imaginary cylindrical surface 20.

The first imaginary cylindrical surface 19 has preferably, but not necessarily, a first diameter A between 100 mm and 300 mm, and the second imaginary cylindrical surface 20 has preferably, but not necessarily, a second diameter B between 300 mm and 700 mm, depending on the burner capacity.

It is apparent to a person skilled in the art that as technology advanced, the basic idea of the invention can be implemented in various ways. The invention and its embodiments are therefore not restricted to the above examples, but they may vary within the scope of the claims.

1.-19. (canceled)

20. A burner such as a concentrate burner or a matte burner for feeding reaction gas and fine solids into a reaction shaft of a suspension smelting furnace,
wherein the burner comprises an annular fine solids discharge channel that is radially limited at the outside by a first annular wall and that is radially limited at the inside by a second annular wall,
wherein the first annular wall being an inner wall of a reaction gas feeding means that surrounds the annular fine solids discharge channel,
wherein the second annular wall being formed by an outer wall of a fine solids dispersion device in the annular fine solids discharge channel,
wherein the annular fine solids discharge channel is configured to receive fine solids from a fine solids feeding arrangement and to create an annular flow of fine solids in the annular fine solids discharge channel, and
wherein the annular fine solids discharge channel is provided with spreading means configured to be hit by the annular flow of fine solids and configured to even out particle distribution in the annular flow of fine solids,
the spreading means is attached to a separate supporting structure arranged in the annular fine solids discharge channel,
the spreading means is unattached to the first annular wall and unattached to the second annular wall, and
the spreading means, which is unattached to the first annular wall and which is unattached to the second annular wall, has a first free end that is situated at a distance from the first annular wall and a second free end that is situated at a distance from the second annular wall.

21. The burner according to claim 20, wherein the fine solids dispersion device in the annular fine solids discharge channel has an enlarged section at an annular outlet opening of the annular fine solids discharge channel, and
the spreading means is arranged in the annular fine solids discharge channel upstream of said enlarged section.

22. The burner according to claim 20, further comprising a supporting structure which is unattached to the first annular wall and unattached to the second annular wall.

23. The burner according to claim 20, wherein the spreading means is in the form of a rod.

24. The burner according to claim 23, wherein the rod has a circular, a triangular, rectangular, or a square cross-section.

25. The burner according to claim 23, wherein the rod extends at least partly perpendicularly with respect to a direction of flow A of the annular flow of fine solids in the annular fine solids discharge channel.

26. The burner according to claim 20, wherein the spreading means is in the form of an annular spreading means.

27. The burner according to claim 20, wherein the annular fine solids discharge channel is additionally configured to receive reaction gas from a reaction gas feeding arrangement so that the annular flow of fine solids in the annular fine solids discharge channel additionally contains reaction gas.
